(19) United States
(12) Patent Application Publication
(10) Pub. No.: US 2023/0303911 A1
(43) Pub. Date: Sep. 28, 2023

(54) Sand Consolidation Compositions And Methods Of Use

(71) Applicant: Xpand Oil & Gas Solutions, LLC, Wayne, PA (US)

(72) Inventor: Amr Radwan, Wayne, PA (US)

(21) Appl. No.: 18/021,496

(22) PCT Filed: Aug. 16, 2021
(86) PCT No.: PCT/US21/46087

§ 371 Date: Feb. 15, 2023

Related U.S. Application Data
(60) Provisional application No. 63/066,468, filed on Aug. 17, 2020.

(51) Int. Cl. C09K 8/57; C09K 8/66; C09K 8/80; E21B 43/267

(52) U.S. Cl. CPC C09K 8/572; C09K 8/665; C09K 8/80; E21B 43/267

(57) ABSTRACT

The present disclosure provides hydraulic fracturing treatment fluid compositions and systems, and methods of controlling proppant flowback and/or controlling sand production in a hydrocarbon-bearing formation using the hydraulic fracturing treatment fluid compositions and systems.

### FIELD

The present disclosure is directed, in part, to proppant flowback and/or sand production control compositions and systems and the methods of their use in hydraulic fracturing hydrocarbon-bearing formations and/or mitigating unconsolidated formations.

### BACKGROUND

Subterranean wells (e.g., hydrocarbon producing wells, gas producing wells, oil producing wells, and the like) are often stimulated by hydraulic fracturing treatments. In traditional hydraulic fracturing treatments, a treatment fluid, which may also function simultaneously or subsequently as a carrier fluid, is pumped into a portion of a subterranean formation (which may also be referred to herein simply as a “formation”) at a rate and pressure sufficient to break down the formation and create one or more fractures therein. Typically, particulate solids, such as graded sand, are suspended in a portion of the treatment fluid and then deposited into the fractures. The particulate solids, known as “proppant particulates” (which may also be referred to herein as “proppant” or “propping particulates”) prevent the fractures from fully closing once the hydraulic pressure is removed. By keeping the fractures from fully closing, the proppant particulates aid in forming conductive paths through which fluids produced from the formation flow, referred to as a “proppant pack.”

A potential drawback from the use of proppants, such as graded sand and ceramic proppants, is flowback resulting in uncontrolled sand/proppant production. This sand/proppant production can damage surface and subsurface equipment, reduce conductivity, and ultimately decrease well productivity. For example, sand production in hydraulically fractured formations can result from flowback of injected frac sand due to low closure pressures and/or high production rates. In hydraulically fractured formations, resin coated proppant (RCP) has been the most common industrial solution. RCP is usually injected as “a tail-in”—the final proppant injected in the final pumping step of a hydraulic fracturing treatment. RCP, however, sometimes, reduces conductivity of the propped fracture pack especially at high temperatures and/or at low closure pressures compared to uncoated proppant. In some multi-cluster treatments, the effectiveness of RCP is greatly reduced due to the practical difficulty of placing RCP in the near-wellbore section. This problem becomes even more troubling with the wide use of low-viscous fluid systems, such as slickwater, wherein the proppant tends to be placed in layers especially with the formation of a near-wellbore “proppant dune” from the early injected proppant. Other methods or preventing or reducing sand production include the injection of liquid resin to control the proppant flowback. However, there are concerns about the conductivity damage caused on these polymers or liquid resin materials.

Sand production can also occur in unconsolidated formations mostly due to the lack of cemented materials in the matrix of the porous media. In these formations, the sand control methods rely on the use of filters to control sand production such as, stand-alone screens (e.g., slotted liner, wire-wrapped screen, prepacked screen and premium screen), which are expensive and involve complex operations). Expandable sand screens have also been used, which are also expensive and involve complex operations. “Gravel Pack & Frack Pack” systems are the most used system, which is also expensive and involve complex operations. Chemical consolidation, such as injection of liquid plastic resin solution and plastic conidiation, may also result in permeability losses.

### SUMMARY

The present disclosure provides water-based hydraulic fracturing treatment fluid systems comprising an uncoated proppant, a metal particle having a size no larger than 20 mesh, and an oxidization promoter.

The present disclosure also provides water-based hydraulic fracturing treatment fluid compositions comprising an uncoated proppant, a metal particle having a size of no larger than 20 mesh, and an oxidization promoter, wherein the metal particle and the oxidization promoter are present in the same composition.

The present disclosure also provides methods of controlling proppant flowback and/or controlling sand production in a hydrocarbon-bearing formation, the method comprising injecting a water-based fluid into the formation, injecting a metal particle into the formation, and injecting an oxidization promoter into the formation, thereby generating in situ proppant consolidation; or injecting a water-based fluid into the formation, mixing a metal particle with an oxidization promoter at the surface of the formation to form a composition, and injecting the composition into the formation, thereby generating in situ sand consolidation.

The present disclosure also provides methods of consolidating loose particles in a formation, the method comprising mixing a metal particle, an oxidization promoter, and water, and injecting the mixed composition into the formation.

### DESCRIPTION OF EMBODIMENTS

The embodiments described herein relate to controlling proppant flowback and/or controlling sand production in a formation by generating in situ proppant/sand consolidation. Specifically, the embodiments described herein relate to reacting a metal particle and an oxidization promoter within a fracture (e.g., a macrofracture or a microfracture) to increase proppant/sand consolidation. The proppant/sand consolidation may be achieved in situ by delaying contact between the metal particle and the oxidization promoter until reaching a desired interval or location downhole within a subterranean formation.

Although some embodiments described herein are illustrated by reference to control treatments (e.g., proppant/sand control), the methods and compositions disclosed herein may be used in any subterranean formation operation that may benefit from their proppant/sand consolidation properties. Such treatment operations can include, but are not limited to, a drilling operation, a stimulation operation, a hydraulic stimulation operation, a proppant control operation, a sand control operation, a completion operation, a scale inhibiting operation, a water-blocking operation, a clay stabilizer operation, a fracturing operation, a frac-packing operation, a gravel packing operation, a wellbore strengthening operation, a sag control operation, or any combination thereof. Furthermore, the embodiments described herein may be used in full-scale subterranean operations or as treatment fluids. The subterranean formation may be any source rock comprising organic matter (e.g., oil or natural gas), such as shale, sandstone, or limestone and may be subsea.

Moreover, the methods and compositions described herein may be used in any non-subterranean operation that may benefit from their proppant/sand consolidation properties. Such operations may be performed in any industry including, but not limited to, oil and gas, mining, chemical, pulp and paper, aerospace, medical, automotive, foundry (molding, core-making, casing), and the like.

As used herein, the phrase “treatment fluid” refers to a relatively small volume of specially prepared fluid (e.g., drilling fluid) placed or circulated in a wellbore.

As used herein, the term “microfracture” refers to a natural or secondary discontinuity in a portion of a subterranean formation creating a flow channel.

As used herein, the term “microfracture” refers to a discontinuity in a portion of a subterranean formation creating a flow channel, the flow channel generally having a diameter or flow size opening greater than about the size of a microfracture. The microfractures and macrofractures may be channels, perforations, holes, or any other ablation within the formation.

As used herein, “about” means that the recited numerical value is approximate and small variations would not significantly affect the practice of the disclosed embodiments. Where a numerical value is used, unless indicated otherwise by the context, “about” means the numerical value can vary by ±10% and remain within the scope of the disclosed embodiments.

As used herein, “comprising” (and any form of comprising, such as “comprise”, “comprises”, and “comprised”), “having” (and any form of having, such as “have” and “has”), “including” (and any form of including, such as “includes” and “include”), or “containing” (and any form of containing, such as “contains” and “contain”), are inclusive and open-ended and include the options following the terms, and do not exclude additional, unrecited elements or method steps.

The present disclosure provides water-based hydraulic fracturing treatment fluid systems comprising an uncoated proppant, a metal particle having a size no larger than 20 mesh, and an oxidization promoter. In some embodiments, the metal particle and the oxidization promoter are capable of creating an in situ oxidation reaction to increase proppants bonding.

In some embodiments, the uncoated proppant is sand, a ceramic, or sintered bauxite, or any combination thereof. In some embodiments, the uncoated proppant is sand. In some embodiments, the uncoated proppant is fracturing sand. In some embodiments, the uncoated proppant is a ceramic. In some embodiments, the uncoated proppant is sintered bauxite. Additional uncoated proppants include, but are not limited to, glass material, polymeric material (e.g., ethylene-vinyl acetate or composite materials), polytetrafluoroethylene material, nut shell pieces, seed shell pieces, fruit pit pieces, wood, and composite particulates, or any combination thereof. Suitable composite particulates may comprise a binder and a filler material, wherein suitable filler materials include, but are not limited to, silica, alumina, fumed carbon, carbon black, graphite, mica, titanium dioxide, barite, meta-silicate, calcium silicate, kaolin, talc, zirconia, boron, fly ash, hollow glass microspheres, and solid glass, or any combination thereof. Suitable uncoated proppants for use in conjunction with the embodiments described herein may be any known shape of material, including substantially spherical materials, fibrous materials, and polygonal materials (e.g., cubic materials), or any combination thereof.

In some embodiments, one or both of the metal particle and oxidization promoter are suspended in an aqueous or non-aqueous solvent. In some embodiments, one or both of the metal particle and oxidization promoter are suspended in a non-aqueous solvent. Suitable examples of non-aqueous solvents include, but are not limited to, aromatic compounds (e.g., benzene and toluene), alcohols (e.g., methanol), esters, ethers, ketones (e.g., acetone), amines, nitrated and halogenated hydrocarbons, liquid ammonia, liquid sulfur dioxide, sulfuryl chloride and sulfuryl chloride fluoride, phosphoryl chloride, dinitrogen tetroxide, antimony trichloride, bromine pentafluoride, hydrogen fluoride, pure sulfuric acid, and other inorganic acids. In some embodiments, one or both of the metal particle and oxidization promoter are suspended in an aqueous solvent. In some embodiments, the metal particle is suspended in a non-aqueous solvent. In some embodiments, the oxidization promoter is suspended in a non-aqueous solvent. In some embodiments, the metal particle is suspended in an aqueous solvent. In some embodiments, the oxidization promoter is suspended in an aqueous solvent. In some embodiments, one or both of the metal particle and oxidization promoter are in a dry form. In some embodiments, the metal particle is in a dry form. In some embodiments, the oxidization promoter is in a dry form.

The water-based hydraulic fracturing treatment fluid system may comprise any base fluid capable of being delivered to a subterranean formation. Suitable base fluids include, but not be limited to, oil-based fluids, aqueous-based fluids, aqueous-miscible fluids, water-in-oil emulsions, and oil-in-water emulsions, or any combination thereof. Suitable oil-based fluids include, but are not limited to, alkanes, olefins, aromatic organic compounds, cyclic alkanes, paraffins, diesel fluids, mineral oils, and desulfurized hydrogenated kerosenes, or any combination thereof. Suitable aqueous-based fluids include fresh water, saltwater (e.g., water containing one or more salts dissolved therein), brine (e.g., saturated saltwater), and seawater, or any combination thereof. Suitable aqueous-miscible fluids include, but not be limited to, alcohols (e.g., methanol, ethanol, n-propanol, isopropanol, n-butanol, sec-butanol, isobutanol, and t-butanol), glycerins, glycols (e.g., polyglycols, propylene glycol, and ethylene glycol), polyglycol amines, and polyols, or derivative thereof, or any in combination with salts (e.g., sodium chloride, calcium chloride, calcium bromide, zinc bromide, potassium carbonate, sodium formate, potassium formate, cesium formate, sodium acetate, potassium acetate, calcium acetate, ammonium acetate, ammonium chloride, ammonium bromide, sodium nitrate, potassium nitrate, ammonium nitrate, ammonium sulfate, calcium nitrate, sodium carbonate, and potassium carbonate), or any in combination with an aqueous-based fluid, or any combination thereof. Suitable water-in-oil and oil-in-water emulsions may comprise any water or oil component described herein. Suitable water-in-oil emulsions, also known as invert emulsions, may have an oil-to-water ratio from a lower limit of greater than about 50:50, greater than about 55:45, greater than about 60:40, greater than about 65:35, greater than about 70:30, greater than about 75:25, or greater than about 80:20 to an upper limit of less than about 100:0, less than about 95:5, less than about 90:10, less than about 85:15, less than about 80:20, less than about 75:25, less than about 70:30, or less than about 65:35 by volume in the base fluid, where the amount may range from any lower limit to any upper limit and encompass any subset therebetween. Suitable oil-in-water emulsions may have a water-to-oil ratio from a lower limit of greater than about 50:50, greater than about 55:45, greater than about 60:40, greater than about 65:35, greater than about 70:30, greater than about 75:25, or greater than about 80:20 to an upper limit of less than about 100:0, less than about 95:5, less than about 90:10, less than about 85:15, less than about 80:20, less than about 75:25, less than about 70:30, or less than about 65:35 by volume in the base fluid, where the amount may range from any lower limit to any upper limit and encompass any subset therebetween. It should be noted that for water-in-oil and oil-in-water emulsions, any mixture of the above may be used including the water being and/or comprising an aqueous-miscible fluid.

In some embodiments, the metal particle is an aluminum particle, a silicon particle, or an iron particle, or any combination thereof. In some embodiments, the metal particle is an aluminum particle. In some embodiments, the metal particle is a silicon particle. In some embodiments, the metal particle is an iron particle. Additional metal particles include, but are not limited to copper, lead, nickel, tin, and zinc.

In some embodiments, the metal particle has a size from about 20 mesh to about 100 mesh, from about 25 mesh to about 80 mesh, from about 30 mesh to about 70 mesh, from about 35 mesh to about 60 mesh, or from about 40 mesh to about 50 mesh. In some embodiments, the metal particle has a size from about 20 mesh to about 100 mesh. In some embodiments, the metal particle has a size from about 25 mesh to about 80 mesh. In some embodiments, the metal particle has a size from about 30 mesh to about 70 mesh. In some embodiments, the metal particle has a size from about 35 mesh to about 60 mesh. In some embodiments, the metal particle has a size from about 40 mesh to about 50 mesh. In some embodiments, the metal particle has a size no larger than 20 mesh. In some embodiments, the metal particle has a size no larger than 25 mesh. In some embodiments, the metal particle has a size no larger than 30 mesh. In some embodiments, the metal particle has a size no larger than 35 mesh. In some embodiments, the metal particle has a size no larger than 40 mesh. In some embodiments, the metal particle has a size no larger than 45 mesh. In some embodiments, the metal particle has a size no larger than 50 mesh. In some embodiments, the metal particle has a size no larger than 60 mesh. In some embodiments, the metal particle has a size no larger than 70 mesh. In some embodiments, the metal particle has a size no larger than 80 mesh. In some embodiments, the metal particle has a size no larger than 100 mesh.

In some embodiments, the aluminum particle is atomized aluminum powder. In some embodiments, the aluminum particle is atomized aluminum powder having an average particle size of no larger than 20 mesh. In some embodiments, the aluminum particle is atomized aluminum powder having an average particle size no larger than 25 mesh. In some embodiments, the aluminum particle is atomized aluminum powder having an average particle size no larger than 30 mesh. In some embodiments, the aluminum particle is atomized aluminum powder having an average particle size no larger than 35 mesh. In some embodiments, the aluminum particle is atomized aluminum powder having an average particle size no larger than 40 mesh. In some embodiments, the aluminum particle is atomized aluminum powder having an average particle size no larger than 45 mesh. In some embodiments, the aluminum particle is atomized aluminum powder having an average particle size no larger than 50 mesh. In some embodiments, the aluminum particle is atomized aluminum powder having an average particle size no larger than 60 mesh. In some embodiments, the aluminum particle is atomized aluminum powder having an average particle size no larger than 70 mesh. In some embodiments, the aluminum particle is atomized aluminum powder having an average particle size no larger than 80 mesh. In some embodiments, the aluminum particle is atomized aluminum powder having an average particle size of no larger than 100 mesh.

In some embodiments, the metal particle may be present in the water-based hydraulic fracturing treatment fluid system in an amount in the range of from a lower limit of about 0.01 pounds per gallon (“lb/gal”), about 0.025 lb/gal, about 0.05 lb/gal, about 0.075 lb/gal, about 0.1 lb/gal, about 0.125 lb/gal, about 0.15 lb/gal, about 0.175 lb/gal, about 0.2 lb/gal, about 0.225 lb/gal, or about 0.25 lb/gal to an upper limit of about 0.5 lb/gal, about 0.475 lb/gal, about 0.45 lb/gal, about 0.425 lb/gal, about 0.4 lb/gal, about 0.375 lb/gal, about 0.35 lb/gal, about 0.325 lb/gal, about 0.3 lb/gal, about 0.275 lb/gal, or about 0.25 lb/gal of the water-based hydraulic fracturing treatment fluid system. In some embodiments, the metal particle may be present in the water-based hydraulic fracturing treatment fluid system in an amount in the range of from a lower limit of about 0.1 lb/gal, about 0.5 lb/gal, about 1 lb/gal, about 1.5 lb/gal, about 2 lb/gal, about 2.5 lb/gal, or about 3 lb/gal to an upper limit of about 6 lb/gal, about 5.5 lb/gal, about 5 lb/gal, about 4.5 lb/gal, about 4 lb/gal, about 3.5 lb/gal, or about 3 lb/gal of the water-based hydraulic fracturing treatment fluid system.

In some embodiments, the oxidization promoter is a hydroxide promoter, a metal oxide promoter, an acid, or a salt promoter, or any combination thereof. In some embodiments, the oxidization promoter is a hydroxide promoter. In some embodiments, the oxidization promoter is a metal oxide promoter. In some embodiments, the oxidization promoter is an acid. In some embodiments, the oxidization promoter is a salt promoter.

In some embodiments, the hydroxide promoter is Ca(OH)₂, Mg(OH)₂, NaOH, or KOH. In some embodiments, the hydroxide promoter is Ca(OH)₂. In some embodiments, the hydroxide promoter is Mg(OH)₂. In some embodiments, the hydroxide promoter is NaOH. In some embodiments, the hydroxide promoter is KOH. In some embodiments, the hydroxide promoter is Mg(OH)₂ or Ca(OH)₂, or a combination thereof. Additional hydroxide promoters include, but are not limited to, ammonia, barium hydroxide, chromium acetate hydroxide, chromium(III) hydroxide, cobalt(II) hydroxide, cobalt(III) hydroxide, copper(I) hydroxide, copper(II) carbonate, copper(II) hydroxide, curium hydroxide, gold(III) hydroxide, lead(II) hydroxide, lead(IV) hydroxide, iron(II) hydroxide, iron(III) oxide-hydroxide, tin(II) hydroxide, uranyl hydroxide, zinc hydroxide, zirconium(IV) hydroxide, mercury(II) hydroxide, and nickel(II) hydroxide, or any combination thereof.

In some embodiments, the metal oxide promoter is CaO or Al₂O₃ (powder). In some embodiments, the metal oxide promoter is CaO. In some embodiments, the metal oxide promoter is Al₂O₃ (powder). Additional metal oxide promoters include, but are not limited to, copper(II) oxide, sodium oxide, potassium oxide, and magnesium oxide, or any combination thereof.

In some embodiments, the salt promoter is NaCl, KCl, CaCl₂, or MgCl₂. In some embodiments, the salt promoter is NaCl. In some embodiments, the salt promoter is KCl. In some embodiments, the salt promoter is CaCl₂. In some embodiments, the salt promoter is MgCl₂. Additional salt promoters include, but are not limited to, sodium bisulfate, copper sulfate, potassium dichromate, ammonium dichlorate, magnesium sulfate, sodium bicarbonate, or any combination thereof.

In some embodiments, the oxidization promoter is in an amount from about 0.001% (wt) to about 50% (wt), from about 0.01% (wt) to about 50% (wt), from about 0.1% (wt) to about 50% (wt), or from about 1.0% (wt) to about 50% (wt) of the metal particle. In some embodiments, the oxidization promoter is in an amount from about 0.001% (wt) to about 50% (wt) of the metal particle. In some embodiments, the oxidization promoter is in an amount from 25 about 0.01% (wt) to about 50% (wt) of the metal particle. In some embodiments, the oxidization promoter is in an amount from about 0.1% (wt) to about 50% (wt) of the metal particle. In some embodiments, the oxidization promoter is in an amount from about 1.0% (wt) to about 50% (wt) of the metal particle. In some embodiments, the oxidization promoter is in an amount from about 0.1% (wt) to about 10% (wt) or from about 0.1% (wt) to about 5% (wt) of the metal particle. In some embodiments, the oxidization promoter is in an amount from about 0.1% (wt) to about 10% (wt) of the metal particle. In some embodiments, the oxidization promoter is in an amount from about 0.1% (wt) to about 5% (wt) of the metal particle.

In some embodiments, the water-based hydraulic fracturing treatment fluid systems further comprise a friction reducer, a gum, a polymer, a proppant, a scale inhibitor, an oxygen scavenger, an iron controller, a crosslinker, a corrosion inhibitor, a breaker, a surfactant, a de-emulsifier, a biocide, an acid, a clay control agent, a versifier, an H₂S scavenger, or any combination thereof. In some embodiments, the water-based hydraulic fracturing treatment fluid systems further comprise a friction reducer. In some embodiments, the water-based hydraulic fracturing treatment fluid systems further comprise a gum. In some embodiments, the water-based hydraulic fracturing treatment fluid systems further comprise a polymer. In some embodiments, the water-based hydraulic fracturing treatment fluid systems further comprise a proppant. In some embodiments, the water-based hydraulic fracturing treatment fluid systems further comprise a scale inhibitor. In some embodiments, the water-based hydraulic fracturing treatment fluid systems further comprise an oxygen scavenger. In some embodiments, the water-based hydraulic fracturing treatment fluid systems further comprise an iron controller. In some embodiments, the water-based hydraulic fracturing treatment fluid systems further comprise a crosslinker. In some embodiments, the water-based hydraulic fracturing treatment fluid systems further comprise a corrosion inhibitor. In some embodiments, the water-based hydraulic fracturing treatment fluid systems further comprise a breaker. In some embodiments, the water-based hydraulic fracturing treatment fluid systems further comprise a surfactant. In some embodiments, the water-based hydraulic fracturing treatment fluid systems further comprise a de-emulsifier. In some embodiments, the water-based hydraulic fracturing treatment fluid systems further comprise a biocide. In some embodiments, the water-based hydraulic fracturing treatment fluid systems further comprise an acid. In some embodiments, the water-based hydraulic fracturing treatment fluid systems further comprise a clay control agent. In some embodiments, the water-based hydraulic fracturing treatment fluid systems further comprise a versifier. In some embodiments, the water-based hydraulic fracturing treatment fluid systems further comprise an H₂S scavenger.

In some embodiments, the water-based hydraulic fracturing treatment fluid system may further comprise a gelling agent. The gelling agent may be any substance (e.g., a polymeric material) capable of increasing the viscosity of the water-based hydraulic fracturing treatment fluid system. In some embodiments, the gelling agent may comprise one or more polymers that have at least two molecules that are capable of forming a crosslink in a crosslinking reaction in the presence of a crosslinking agent, and/or polymers that have at least two molecules that are so crosslinked (i.e., a crosslinked gelling agent). The gelling agents may be naturally-occurring gelling agents; synthetic gelling agents; and any combination thereof. Suitable gelling agents include, but are not limited to, a polysaccharide; a biopolymer; and/or derivatives thereof that contain one or more of these monosaccharide units: galactose, mannose, glucoside, glucose, xylose, arabinose, fructose, glucuronic acid, or pyranosyl sulfate. Examples of suitable polysaccharides include, but are not limited to, a guar gum (e.g., hydroxyethyl guar, hydroxypropyl guar, carboxymethyl guar, carboxymethyl hydroxyethyl guar, and carboxymethylhydroxypropyl guar); a cellulose; a cellulose derivative (e.g., hydroxyethyl cellulose, carboxyethylcellulose, carboxymethylcellulose, and carboxymethylhydroxyethylcellulose); xanthan; scleroglucan; succinoglycan; diutan; and any combination thereof.

Suitable synthetic polymers for use as gelling agents include, but are not limited to, 2,2′-azobis(2,4-dimethyl valeronitrile); 2,2′-azobis(2,4-dimethyl-4-methoxy valeronitrile); polymers and copolymers of acrylamide ethyltrimethyl ammonium chloride; acrylamide; acrylamido-alkyl trialkyl ammonium salts; methacrylamido-alkyl trialkyl ammonium salts; acrylamidomethylpropane sulfonic acid; acrylamidopropyl trimethyl ammonium chloride; acrylic acid; dimethylaminoethyl methacrylamide; dimethylaminoethyl methacrylate; dimethylaminopropyl methacrylamide; dimethylaminopropylmethacrylamide; dimethyldiallylammonium chloride; dimethylethyl acrylate; fumaramide; methacrylamide; methacrylamidopropyl trimethyl ammonium chloride; methacrylamidopropyldimethyl-n-dodecylammonium chloride; methacrylamidopropyldimethyl-n-octylammonium chloride; methacrylamidopropyltrimethylammonium chloride; methacryloylalkyl trialkyl ammonium salts; methacryloylethyl trimethyl ammonium chloride; methacrylylamidopropyl dimethylcetylammonium chloride; N-(3-sulfopropyl)-N-methacrylamidopropyl-N,N-dimethyl ammonium betaine; N,N-dimethylacrylamide; N-methylacrylamide; nonylphenoxypoly(ethyleneoxy)ethylmethacrylate; partially hydrolyzed polyacrylamide; poly 2-amino-2-methyl propane sulfonic acid; polyvinyl alcohol; sodium 2-acrylamido-2-methylpropane sulfonate; quaternized dimethylaminoethylacrylate; quaternized dimethylaminoethylmethacrylate; any derivative thereof and any combination thereof. In some embodiments, the gelling agent comprises an acrylamide/2-(methacryloyloxy) ethyltrimethylammonium methyl sulfate copolymer. In some embodiments, the gelling agent may comprise an acrylamide/2-(methacryloyloxy)ethyltrimethylammonium chloride copolymer. In other embodiments, the gelling agent may comprise a derivatized cellulose that comprises cellulose grafted with an allyl or a vinyl monomer.

Additionally, polymers and copolymers that comprise one or more functional groups (e.g., hydroxyl, cis-hydroxyl, carboxylic acids, derivatives of carboxylic acids, sulfate, sulfonate, phosphate, phosphonate, amino, or amide groups) may be used as gelling agents.

The gelling agent may be present in the water-based hydraulic fracturing treatment fluid system of the embodiments described herein in an amount sufficient to provide the desired viscosity. In some embodiments, the gelling agents (i.e., the polymeric material) may be present in an amount in the range of from a lower limit of about 0.1%, about 0.25%, about 0.5%, about 0.75%, about 1%, about 1.25%, about 1.5%, about 1.75%, about 2%, about 2.25%, about 2.5%, about 2.75%, about 3%, about 3.25%, about 3.5%, about 3.75%, about 4%, about 4.25%, about 4.5%, about 4.75%, or about 5% (wt) to an upper limit of about 10%, about 9.75%, about 9.5%, about 9.25%, about 9%, about 8.75%, about 8.5%, about 8.25%, about 8%, about 7.75%, about 7.5%, about 7.25%, about 7%, about 6.75%, about 6.5%, about 6.25%, about 6%, about 5.75%, about 5.5%, about 5.25%, and about 5% (wt) of the treatment fluid. In some embodiments, the gelling agent is present in an amount in the range of from about 0.15% to about 2.5% (wt) of the water-based hydraulic fracturing treatment fluid system.

In those embodiments described herein where it is desirable to crosslink the gelling agent(s), the water-based hydraulic fracturing treatment fluid system may comprise one or more crosslinking agents. The crosslinking agents may comprise a borate ion, a metal ion, or similar component that is capable of crosslinking at least two molecules of the gelling agent. Examples of suitable crosslinking agents include, but are not limited to, a borate ion; a magnesium ion; a zirconium IV ion; a titanium IV ion; an aluminum ion; an antimony ion; a chromium ion; an iron ion; a copper ion; a magnesium ion; a zinc ion; and any combination thereof. These ions may be provided by providing any compound that is capable of producing one or more of these ions. Examples of such compounds include, but are not limited to, ferric chloride; boric acid; disodium octaborate tetrahydrate; sodium diborate; a pentaborate; ulexite; colemanite; magnesium oxide; zirconium lactate; zirconium triethanol amine; zirconium lactate triethanolamine; zirconium carbonate; zirconium acetylacetonate; zirconium malate; zirconium citrate; zirconium diisopropylamine lactate; zirconium glycolate; zirconium triethanol amine glycolate; zirconium lactate glycolate; titanium lactate; titanium malate; titanium citrate; titanium ammonium lactate; titanium triethanolamine; titanium acetylacetonate; aluminum lactate; aluminum citrate; an antimony compound; a chromium compound; an iron compound; a copper compound; a zinc compound; and any combination thereof. In some embodiments, the crosslinking agent may be formulated to remain inactive until it is “activated” by, among other things, certain conditions in the treatment fluid (e.g., pH, temperature, etc.) and/or interaction with some other substance. In some embodiments, the activation of the crosslinking agent may be delayed by encapsulation with a coating (e.g., a porous coating through which the crosslinking agent may diffuse slowly, or a degradable coating that degrades downhole) that delays the release of the crosslinking agent until a desired time or place. The choice of a particular crosslinking agent will be governed by several considerations that will be recognized by one skilled in the art, including but not limited, the type of gelling agent(s) selected, the molecular weight of the gelling agent(s) selected, the conditions in the subterranean formation being treated, the safety handling requirements, the pH of the water-based hydraulic fracturing treatment fluid system, the temperature of the subterranean formation, the desired delay for the crosslinking agent to crosslink the gelling agent molecules, and the like.

When included, suitable crosslinking agents may be present in the water-based hydraulic fracturing treatment fluid system useful in the embodiments described herein in an amount sufficient to provide the desired degree of crosslinking between molecules of the gelling agent. In some embodiments, the crosslinking agent may be present in an amount in the range of from a lower limit of about 0.005%, about 0.05%, about 0.1%, about 0.15%, about 0.2%, about 0.25%, about 0.3%, about 0.35%, about 0.4%, about 0.45%, or about 0.5% to an upper limit of about 1%, about 0.95%, about 0.9%, about 0.85%, about 0.8%, about 0.75%, about 0.7%, about 0.65%, about 0.6%, about 0.55%, or about 0.5% (wt) of the water-based hydraulic fracturing treatment fluid system. In some embodiments, the crosslinking agent may be present in an amount in the range of from about 0.05% to about 1% (wt) of the water-based hydraulic fracturing treatment fluid system. One of ordinary skill in the art, with the benefit of this disclosure, will recognize the appropriate amount of crosslinking agent to include in a water-based hydraulic fracturing treatment fluid system of the embodiments described herein based on a number of factors, such as the temperature conditions of a particular application, the type of gelling agents selected, the molecular weight of the gelling agents, the desired degree of viscosification, the pH of the treatment fluid, and the like.

In some embodiments, the water-based hydraulic fracturing treatment fluid systems further comprise a third component comprising a wettability modifier. In some embodiments, the third component comprising the wettability modifier is present within the first component. In some embodiments, the third component comprising the wettability modifier is present within the second component. In some embodiments, the third component comprising the wettability modifier is separate from both the first component and the second component.

In some embodiments, the wettability modifier is in an amount from about 1 to about 20 gallons, from about 2 to about 15 gallons, from about 5 to about 120 gallons, or from about 8 to about 10 gallons, per 1000 gallons of treatment fluid. In some embodiments, the wettability modifier is in an amount from about 1 to about 20 gallons per 1000 gallons of treatment fluid. In some embodiments, the wettability modifier is in an amount from about 2 to about 15 gallons per 1000 gallons of treatment fluid. In some embodiments, the wettability modifier is in an amount from about 5 to about 120 gallons per 1000 gallons of treatment fluid. In some embodiments, the wettability modifier is in an amount from about 8 to about 10 gallons per 1000 gallons of treatment fluid.

In some embodiments, the wettability modifier is a nanofluid, a micro emulsion, a nano emulsion, a polymer, a fluorinated material, a silane, or a surfactant, or any combination thereof. In some embodiments, the wettability modifier is a nanofluid. In some embodiments, the wettability modifier is a micro emulsion. In some embodiments, the wettability modifier is a nano emulsion. In some embodiments, the wettability modifier is a polymer. In some embodiments, the wettability modifier is a polymer. In some embodiments, the wettability modifier is a fluorinated material. In some embodiments, the wettability modifier is a silane. In some embodiments, the wettability modifier is a surfactant.

In some embodiments, the wettability modifier is a silica, an alumina, or a titania nano-dispersion. In some embodiments, the wettability modifier is a silica nano-dispersion. In some embodiments, the wettability modifier is an alumina nano-dispersion. In some embodiments, the wettability modifier is a titania nano-dispersion.

In some embodiments, the wettability modifier is an anionic, nano-ionic, or cationic siloxane surfactant or fluorosurfactant. In some embodiments, the wettability modifier is an anionic siloxane surfactant or fluorosurfactant. In some embodiments, the wettability modifier is nano-ionic siloxane surfactant or fluorosurfactant. In some embodiments, the wettability modifier is a cationic siloxane surfactant or fluorosurfactant.

In some embodiments, the polymer is a fluoropolymer. In some embodiments, the fluoropolymer is polytetrafluoroethylene (PTFE).

The present disclosure also provides water-based hydraulic fracturing treatment fluid compositions comprising any of the uncoated proppants, metal particles, and oxidization promoters described herein. In some embodiments, the metal particle and the oxidization promoter are present in the same composition. In some embodiments, the water-based hydraulic fracturing treatment fluid compositions further comprise any of the components described herein.

The present disclosure also provides methods of controlling proppant flowback and/or controlling sand production in a hydrocarbon-bearing formation, the methods comprising: injecting a water-based fluid into the formation, injecting a metal particle into the formation, and injecting an oxidization promoter into the formation, thereby generating in situ proppant consolidation; or injecting a water-based fluid into the formation, mixing a metal particle with an oxidization promoter at the surface of the formation to form a composition, and injecting the composition into the formation, thereby generating in situ sand consolidation. In some embodiments, the methods are for controlling proppant flowback. In some embodiments, the methods are for controlling sand production. In some embodiments, the methods are for controlling proppant flowback and sand production.

The reaction between the metal particle and water, facilitated by the oxidization promoter, results in oxidized metal bound with the surrounding sand/proppant which in turn consolidates the sand/proppant. The sand/proppant consolidation diminishes the amount of free flowing sand/proppant that would accumulate undesirably.

In some embodiments, the metal particle is injected into the formation prior to injecting the oxidization promoter. In some embodiments, the metal particle is injected into the formation after injecting the oxidization promoter. In some embodiments, the metal particle and the oxidization promoter are mixed while injecting both components into the formation at about the same time. In some embodiments, the metal particle and the oxidization promoter are injected into the formation prior to or at about the same time as injecting a proppant-laden slurry.

In any of the methods of controlling proppant flowback and/or controlling sand production in a hydrocarbon-bearing formation described herein, any of the uncoated proppants, metal particles, and/or oxidization promoters described herein can be used. In any of the methods of controlling proppant flowback and/or controlling sand production in a hydrocarbon-bearing formation described herein, any of the friction reducers, gums, polymers, proppants, scale inhibitors, oxygen scavengers, iron controllers, crosslinkers, corrosion inhibitors, breakers, surfactants, de-emulsifiers, biocides, acids, clay control agents, versifiers, or H₂S scavengers, or any combinations thereof, can also be injected into the formation.

In some embodiments, the methods described herein further comprise injecting a wettability modifier into the formation. In any of the methods of hydraulic fracturing a hydrocarbon-bearing formation described herein, any of the wettability modifiers described herein can be used.

In some embodiments, the wettability modifier is mixed with the metal particle and/or the oxidization promoter at the surface of the formation to form a composition, prior to injecting the composition into the formation.

In some embodiments, the amount of the metal particle injected into the formation is less than about 20%, or less than about 0.01% of the total treatment fluid injected into the formation. In some embodiments, the amount of the metal particle injected into the formation is less than about 10%, or less than about 0.1% of the total treatment fluid injected into the formation. In some embodiments, the amount of the metal particle injected into the formation is less than about 5%, or less than about 1% of the total treatment fluid injected into the formation. In some embodiments, the amount of the oxidization promoter injected into the formation is from about 0.001% to about 50% of the metal particle injected into the formation. In some embodiments, the amount of the oxidization promoter injected into the formation is from about 0.01% to about 25% of the metal particle injected into the formation. In some embodiments, the amount of the oxidization promoter injected into the formation is from about 0.1% to about 10% of the metal particle injected into the formation. In some embodiments, the amount of the oxidization promoter injected into the formation is from about 0.5% to about 2% of the metal particle injected into the formation.

In any of the methods of controlling proppant flowback and/or controlling sand production in a hydrocarbon-bearing formation described herein, the metal particle and/or the oxidization promoter may be introduced into the subterranean formation at a rate and pressure sufficient to create or enhance sand/proppant bonding in the first treatment interval. In some embodiments, the water-based hydraulic fracturing treatment fluid system (including the metal particle and the oxidization promoter) and/or the water-based fluid may be introduced into the subterranean formation using a hydrojetting tool. The hydrojetting tool may be connected to a tubular member and have a hydrojetting nozzle. The hydrojetting tool may be configured such that fluid flowed therethrough and out the hydrojetting nozzle may be at a pressure sufficient to create or enhance sand/proppant bonding in a subterranean formation. In some embodiments, the metal particle and/or the oxidization promoter may be introduced into the subterranean formation through the hydrojetting tool and out the hydrojetting nozzle at a rate and pressure sufficient to create sand/proppant bonding.

The tubular member of the hydrojetting tool may be within the subterranean formation such that an annulus is formed between the tubular member and the subterranean formation. In some embodiments, either the metal particle and/or the oxidization promoter or the water-based fluid may be introduced into the subterranean formation through the hydrojetting tool and the other of the metal particle and/or the oxidization promoter or the water-based fluid may be introduced into the subterranean formation through the annulus. In other embodiments, the water-based fluid may be introduced through the hydrojetting tool, followed immediately by introduction of the metal particle and/or the oxidization promoter through the same hydrojetting tool. In those embodiments in which a the metal particle and the oxidization promoter are used, one of the metal particle or the oxidization promoter may be introduced into the subterranean through the hydrojetting tool and the other of the metal particle and/or the oxidization promoter may be introduced into the subterranean formation through the annulus. The water-based fluid may then be introduced either through the annulus or through the same hydrojetting tool.

In various embodiments, systems configured for delivering the treatment fluids (i.e., water-based hydraulic fracturing treatment fluid system (including the metal particle and the oxidization promoter) and the water-based fluid) described herein to a downhole location are described. In various embodiments, the systems can comprise a pump fluidly coupled to a tubular, the tubular containing the treatment fluids described herein. It will be appreciated that while the system described below may be used for delivering either or both of the temporary sealant slurry and the fracturing fluid, each treatment fluid is delivered separately into the subterranean formation.

The pump may be a high pressure pump in some embodiments. As used herein, the term “high pressure pump” will refer to a pump that is capable of delivering a fluid downhole at a pressure of about 1000 psi or greater. A high pressure pump may be used when it is desired to introduce the water-based hydraulic fracturing treatment fluid system to a subterranean formation at or above a fracture gradient of the subterranean formation, but it may also be used in cases where fracturing is not desired. In some embodiments, the high pressure pump may be capable of fluidly conveying particulate matter, such as the metal particles and/or the oxidization promoters described herein, into the subterranean formation. Suitable high pressure pumps include, but are not limited to, floating piston pumps and positive displacement pumps.

In other embodiments, the pump may be a low pressure pump. As used herein, the term “low pressure pump” will refer to a pump that operates at a pressure of about 1000 psi or less. In some embodiments, a low pressure pump may be fluidly coupled to a high pressure pump that is fluidly coupled to the tubular. That is, in such embodiments, the low pressure pump may be configured to convey the water-based hydraulic fracturing treatment fluid system to the high pressure pump. In such embodiments, the low pressure pump may “step up” the pressure of the water-based hydraulic fracturing treatment fluid system before reaching the high pressure pump.

In some embodiments, the systems described herein can further comprise a mixing tank that is upstream of the pump and in which the water-based hydraulic fracturing treatment fluid system is formulated. In various embodiments, the pump (e.g., a low pressure pump, a high pressure pump, or a combination thereof) may convey the water-based hydraulic fracturing treatment fluid system from the mixing tank or other source of the water-based hydraulic fracturing treatment fluid system to the tubular. In other embodiments, however, the water-based hydraulic fracturing treatment fluid system may be formulated offsite and transported to a worksite, in which case the water-based hydraulic fracturing treatment fluid system may be introduced to the tubular via the pump directly from its shipping container (e.g., a truck, a railcar, a barge, or the like) or from a transport pipeline. In either case, the water-based hydraulic fracturing treatment fluid system may be drawn into the pump, elevated to an appropriate pressure, and then introduced into the tubular for delivery downhole.

It is also to be recognized that the disclosed water-based hydraulic fracturing treatment fluid systems may also directly or indirectly affect the various downhole equipment and tools that may come into contact with the water-based hydraulic fracturing treatment fluid system during operation. Such equipment and tools include, but are not limited to, wellbore casing, wellbore liner, completion string, insert strings, drill string, coiled tubing, slickline, wireline, drill pipe, drill collars, mud motors, downhole motors and/or pumps, surface-mounted motors and/or pumps, centralizers, turbolizers, scratchers, floats (e.g., shoes, collars, valves, etc.), logging tools and related telemetry equipment, actuators (e.g., electromechanical devices, hydromechanical devices, etc.), sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like.

In some embodiments, the injection rate of the water, metal particle and/or the oxidization promoter is from about 0.1 bbl/min to about 30 bbl/min, from about 1.0 bbl/min to about 25 bbl/min, from about 5.0 bbl/min to about 20 bbl/min, or from about 10.0 bbl/min to about 15 bbl/min. In some embodiments, the injection rate is from about 0.1 bbl/min to about 30 bbl/min. In some embodiments, the injection rate is from about 1.0 bbl/min to about 25 bbl/min. In some embodiments, the injection rate is from about 5.0 bbl/min to about 20 bbl/min. In some embodiments, the injection rate is from about 10.0 bbl/min to about 15 bbl/min. In some embodiments, the injection rate is from about 0.5 bbl/min to about 10 bbl/min.

For frac operations, in some embodiments the Al dispersion and oxidation promoter are delivered to a wellsite. In some embodiments, the metal particles (and/or oxidation promoter) can be premixed with sand in a mine or a transload facility before transport to a wellsite. In some embodiments, the metal particles and oxidation promoter can be mixed onsite as dry materials. For frac operations, in some embodiments, the materials can be injected either during injection of sand-laden slurry or as a flush stage after injection of the frac sand or a combination thereof.

For the sand control in unconsolidated formations, in some embodiments, the materials can be injected into the formation at a pressure higher than the current reservoir pressure to allow squeezing the materials into the rock. In some embodiments, the metal particles and oxidation promoter can be injected without water if the formation contains formation water.

The present disclosure also provides methods of consolidating loose particles in a formation, the method comprising mixing a metal particle, an oxidization promoter, and water, and injecting the mixed composition into the formation. In some embodiments, the formation is a hydrocarbon-bearing formation. In some embodiments, the consolidation of loose particles in a formation occurs in, for example, foundry applications (e.g., molding, core-making, casing operations) or to create sand bonding to fill the joints between concrete pavers and/or brick pavers.

In any of the methods of consolidating loose particles in a formation described herein, any of the metal particles and oxidization promoters described herein can be used.

In any of the methods of consolidating loose particles in a formation described herein, any of the friction reducers, gums, polymers, proppants, scale inhibitors, oxygen scavengers, iron controllers, crosslinkers, corrosion inhibitors, breakers, surfactants, de-emulsifiers, biocides, acids, clay control agents, versifiers, or H₂S scavengers, or any combinations thereof, can also be injected into the formation.

In some embodiments, the amount of the metal particle injected into the formation is less than about 20%, or less than about 0.01% of the total treatment fluid injected into the formation. In some embodiments, the amount of the metal particle injected into the formation is less than about 10%, or less than about 0.1% of the total treatment fluid injected into the formation. In some embodiments, the amount of the metal particle injected into the formation is less than about 5%, or less than about 1% of the total treatment fluid injected into the formation. In some embodiments, the amount of the oxidization promoter injected into the formation is from about 0.001% to about 50% of the metal particle injected into the formation. In some embodiments, the amount of the oxidization promoter injected into the formation is from about 0.01% to about 25% of the metal particle injected into the formation. In some embodiments, the amount of the oxidization promoter injected into the formation is from about 0.1% to about 10% of the metal particle injected into the formation. In some embodiments, the amount of the oxidization promoter injected into the formation is from about 0.5% to about 2% of the metal particle injected into the formation.

In order that the subject matter disclosed herein may be more efficiently understood, examples are provided below. It should be understood that these examples are for illustrative purposes only and are not to be construed as limiting the claimed subject matter in any manner.

### EXAMPLES

### Example 1: Sand Consolidation Compositions

The components in Table 1 were mixed for 30 seconds at 100° F., then the mixture was placed inside a flask (opening facing at the bottom) and visually observed for hydrogen gas generation reaction and/or a temperature change. Gas generation was observed after about 180 minutes at ambient conditions. After about 60 seconds, gas bubbles were slowly generated, and the water started to flow out of the flask, and after about 120 minutes, all the water was out of the flask. It was observed that the temperature of the mixture was not increased due to the reaction. Surprisingly, it was observed that the sand consolidated after all the water was removed.

TABLE 1

| Component | Amount |
|---|---|
| Water | 0.25 gal |
| Sand | 0.20 lb |
| Al powder | 5.0% wt of sand |
| Ca(OH)₂ | 5.0% wt of Al powder |

### Example 2: Frac Sand Consolidation Method (Prophetic)

Immediately after a hydrocarbon-bearing formation is hydraulically fractured with a sand-laden-slurry, a sand consolidation treatment mixture, as shown in Table 2, is pumped into the formation to increase sand consolidation in the near-wellbore proppant pack. The sand consolidation treatment mixture is then followed by a flush stage equivalent to the wellbore volumetric capacity to ensure all treatment mixture is displaced from the wellbore.

TABLE 2

| Component | Amount |
|---|---|
| Water | 500 gal |
| 50 wt % Al Dispersion | 50 gal |
| 20 wt % Mg(OH)₂ Solution | 5 gal |

### Example 3: Sand Production Control Method (Prophetic)

A formation suffering from severe sand production due to the lack of cementing materials in the matrix, is treated with a sand consolidation treatment mixture, as shown in Table 3 to increase sand consolidation in the near-wellbore formation zone. The mixture is then followed by a flush stage equivalent to the wellbore volumetric capacity to ensure all treatment mixture is displaced from the wellbore.

TABLE 3

| Component | Amount |
|---|---|
| Water | 1000 gal |
| Al powder | 1000 lb |
| CaO | 5 lb |

Various modifications of the described subject matter, in addition to those described herein, will be apparent to those skilled in the art from the foregoing description. Such modifications are also intended to fall within the scope of the appended claims. Each reference (including, but not limited to, journal articles, U.S. and non-U.S. patents, patent application publications, international patent application publications, gene bank accession numbers, and the like) cited in the present application is incorporated herein by reference in its entirety.

1-47. (canceled)

48. A composition comprising: a metal particle, an oxidization promoter, and water.

49. The composition of claim 48, wherein the metal particle is an aluminum particle, a silicon particle, or an iron particle, or any combination thereof.

50. The composition of claim 48, wherein the metal particle has a size no larger than 20 mesh.

51. The composition of claim 48, wherein the metal particle has a size no larger than 100 mesh.

52. The composition of claim 48, wherein the metal particle is an aluminum particle.

53. The composition of claim 52, wherein the aluminum particle is atomized aluminum powder having an average particle size of no larger than 20 mesh.

54. The composition of claim 52, wherein the aluminum particle is atomized aluminum powder having an average particle size of no larger than 100 mesh.

55. The composition of claim 48, wherein the oxidization promoter is a hydroxide promoter, a metal oxide promoter, an acid, or a salt promoter, or any combination thereof.

56. The composition of claim 48, wherein the oxidization promoter is a hydroxide promoter.

57. The composition of claim 56, wherein the hydroxide promoter is Ca(OH)₂, Mg(OH)₂, NaOH, or KOH.

58. The composition of claim 57, wherein the hydroxide promoter is Ca(OH)2 in an amount from about 0.001% (wt) to about 50% (wt) of the metal particle.

59. The composition of claim 57, wherein the hydroxide promoter is Ca(OH)₂ in an amount from about 0.1% (wt) to about 10% (wt) of the metal particle.

60. The composition of claim 48, further comprising loose particles.

61. The composition of claim 60, wherein the loose particles are uncoated proppants or unconsolidated formation sand, or a combination thereof.

62. The composition of claim 61, wherein the uncoated proppants are sand, a ceramic, or sintered bauxite, or any combination thereof.

63. The composition of claim 61, wherein the uncoated proppants are sand.

64. The composition of claim 63, wherein the sand is fracturing sand.

65. The composition of claim 48 comprising water, sand, aluminum powder, and Ca(OH)₂.

66. A method of consolidating loose particles in a formation, the method comprising injecting the composition of claim 48 into the formation.
